(19) United States
(12) Patent Application Publication
(10) Pub. No.: US 2026/0205300 A1
(43) Pub. Date: Jul. 16, 2026

(54) CAMERA SYSTEM

(71) Applicants: DENSO CORPORATION, Kariya-city (JP); TOYOTA JIDOSHA KABUSHIKI KAISHA, Toyota-shi (JP)

(72) Inventors: Yusuke NAKAGAWA, Kariya-city (JP); Tomoyasu TAMAOKI, Okazaki-shi (JP)

(21) Appl. No.: 19/446,506

(22) Filed: Jan. 12, 2026

(30) Foreign Application Priority Data
Jan. 14, 2025 (JP) 2025-004779

(51) Int. Cl. H04L 9/32; H04N 23/66

(52) U.S. Cl. CPC H04L 9/3236; H04N 23/66

(57) ABSTRACT

A camera system includes a data storage unit storing predefined data to be protected, and a non-rewritable storage unit storing a first hash value that is a hash value pre-calculated using a predefined hash function based on the data to be protected, and an imaging unit configured to perform an imaging operation for converting received light into an electrical signal. The camera system further includes a function storage unit storing the predefined hash function, a hash value calculation unit configured to, when an imaging initiation request is provided to initiate the imaging operation, calculate a second hash value based on the data to be protected using the predefined hash function stored in the function storage unit, and a determination unit configured to determine whether the first hash value and the second hash value match.

### CROSS-REFERENCE TO RELATED APPLICATION

This application is based on and claims the benefit of priority from earlier Japanese Patent Application No. 2025-004779 filed January 14, 2025, the description of which is incorporated herein by reference.

### BACKGROUND

### Technical Field

This disclosure relates to a camera system.

### Related Art

This known vehicle control system includes a plurality of control devices and a plurality of communication networks connecting the plurality of control devices to each other. At least one of the plurality of control devices has a gateway function that relays data between the communication networks. When the non-volatile memory of any of the control devices is rewritten, rewrite information is stored in the non-volatile memory of a control device selected from the at least one of the plurality of control devices having the gateway function, which is not subject to rewriting.

### BRIEF DESCRIPTION OF THE DRAWINGS

In the accompanying drawings:

FIG. 1 is a block diagram illustrating a schematic hardware configuration of a camera system according to a first embodiment;

FIG. 2 is a block diagram illustrating a schematic functional configuration of a control unit included in a camera control device that constitutes a part of the camera system according to the first embodiment;

FIG. 3 is a block diagram illustrating the schematic configuration of manufacturing equipment used in the manufacturing process of the camera system in the first embodiment, and the schematic internal configurations of the camera and the camera control device during the camera system manufacturing process;

FIG. 4 is a flowchart illustrating the process in which various data is written to the camera-internal memory and the imager's internal memory during camera manufacturing in the first embodiment;

FIG. 5 is a flowchart of the control process performed by the control unit of the camera control device in the first embodiment; and

FIG. 6 is a block diagram illustrating the schematic internal configuration of the camera and the camera control device during execution of the control process illustrated in FIG. 5 in the completed camera system of the first embodiment.

### DESCRIPTION OF SPECIFIC EMBODIMENTS

In an internal memory of a camera included in a camera system, various data, such as optical correction parameters for correcting optical properties of the camera, are stored.

Rewriting these various data stored in the internal memory of the camera may degrade the optical properties of the camera. For example, in a case where the camera system is mounted to a vehicle, the camera system may fail to comply with laws and regulations.

From such circumstances, it has been considered necessary to provide a technique capable of detecting that data stored in a memory included in a camera system has been rewritten. However, the tamper-prevention technique used in the above known vehicle control system, as disclosed in Japanese Patent No. 6731892, presupposes that there are a plurality of control devices capable of mutually communicating with each other. Therefore, it is difficult to apply that tamper-prevention technique to the above camera system. As a result of detailed studies conducted by the inventors, the above findings have been acquired.

In view of the foregoing, it is desired to have a technique capable of detecting that data stored in a memory in a camera system has been rewritten when such rewriting occurs.

One aspect of the present disclosure provides a camera system including: a data storage unit storing predefined data to be protected; a non-rewritable storage unit storing a first hash value that is a hash value pre-calculated using a predefined hash function based on the data to be protected; an imaging unit configured to perform an imaging operation for converting received light into an electrical signal; a function storage unit storing the predefined hash function; a hash value calculation unit configured to, when an imaging initiation request is provided to initiate the imaging operation, calculate a second hash value based on the data to be protected using the predefined hash function stored in the function storage unit; and a determination unit configured to determine whether the first hash value and the second hash value match.

In this configuration, a match between the first hash value and the second hash value means that the data to be protected at the time of calculating the second hash value is the same as the data on which the first hash value was based. In contrast, a mismatch between the first hash value and the second hash value means that the data to be protected at the time of calculating the second hash value has changed from the data on which the first hash value was based. Therefore, in a case where the data to be protected stored in the data storage unit has been rewritten, it is possible to detect that the data to be protected has been rewritten based on the determination result provided by the determination unit.

In this specification, reference numerals in parentheses may be appended to respective elements. In such cases, the reference numerals merely indicate an example of correspondence between the elements and specific configurations described in the embodiments to be described later. Accordingly, the present disclosure is not limited in any way by the indication of such reference numerals.

Hereinafter, some embodiments will be described with reference to the drawings. In the respective embodiments described below, including other embodiments to be described later, identical or equivalent portions are denoted by the same reference numerals in the drawings.

### First Embodiment

A camera system 10 according to a first embodiment is an on-board camera system for a vehicle. The vehicle to which the on-board camera system is mounted is hereinafter referred to as a subject vehicle. For example, the camera system 10 may perform various vehicle control, such as automatic brake control for automatically actuating a braking device of the vehicle, based on captured image information from a camera 12 included in the camera system 10.

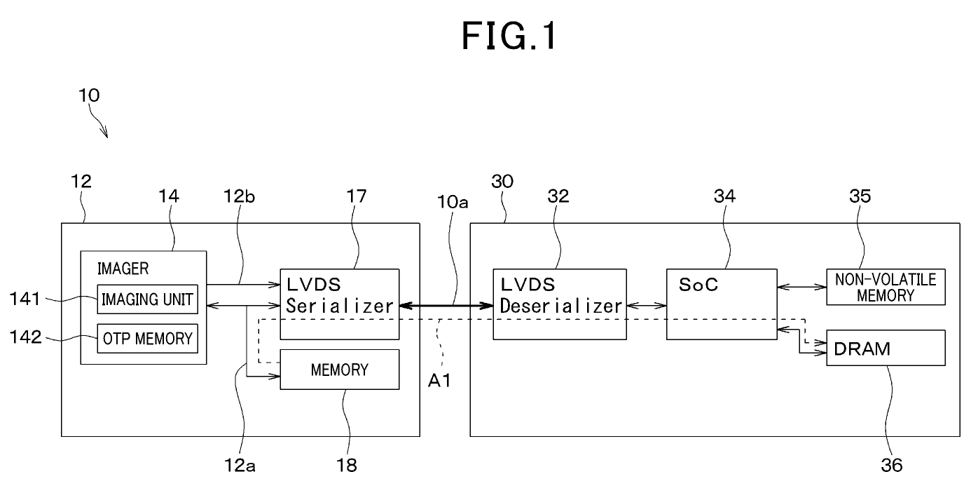

As illustrated in FIG. 1, the camera system 10 includes a camera 12 and a camera control device 30. The camera 12 and the camera control device 30 are configured as separate devices and are connected to each other via a communication line 10a such as a coaxial cable. That is, the camera 12 and the camera control device 30 are communicably connected to each other.

The camera 12 is an on-board camera that captures an image of an area forward of a vehicle, and is disposed, for example, at an upper end portion on the cabin side of a windshield or at a front grille of the vehicle. Specifically, the camera 12 includes an imager 14, a serializer 17, and a camera-internal memory 18 that serves as a data storage unit.

The imager 14, the serializer 17, and the camera-internal memory 18 of the camera 12 are communicably connected to each other within the camera 12. For example, in the present embodiment, although various connection methods between these components are conceivable, the imager 14, the serializer 17, and the camera-internal memory 18 are interconnected via a first bus 12a, which is a serial bus such as an I2C bus. In addition, the imager 14 and the serializer 17 are interconnected via a second bus 12b, which is a parallel bus. An electrical signal representing the captured image data from the imager 14 is transmitted via the second bus 12b, whereas other electrical signals, such as those indicating control commands or various parameters, are transmitted via the first bus 12a. The term “I2C bus” is an abbreviation for “Inter-Integrated Circuit.”

The imager 14 is constituted of a semiconductor element, such as a CCD element or a CMOS element, and includes an imaging unit 141 and an imager-internal memory 142. In other words, the imaging unit 141 and the imager-internal memory 142 together constitute the imager 14, which is a single imaging element. The term “CCD” is an abbreviation for “Charge-Coupled Device,” and “CMOS” is an abbreviation for “Complementary Metal-Oxide Semiconductor.”

The imaging unit 141 is a part of the imager 14 that performs an imaging operation for converting received light into an electrical signal. The imaging unit 141 receives light from outside the camera 12 through a lens (not shown) provided in the camera 12. In the imaging operation, the imaging unit 141 generates and outputs, at a predefined frame rate, an electrical signal corresponding to the received light as captured image data.

The imager-internal memory 142 is a non-rewritable storage in which data once written cannot be rewritten. Specifically, the imager-internal memory 142 is a type of non-volatile memory that is writable only once, known as an OTP memory. The term “OTP” is an abbreviation for “One Time Program.”

The serializer 17 is comprised of an electronic circuit including, for example, a plurality of electronic devices. The serializer 17 and a deserializer 32 of the camera control device 30 are communicably connected to each other via the communication line 10a described above.

The serializer 17 converts a parallel signal, input from the imaging unit 141 as captured image data, into a serial signal, and outputs the converted serial signal to the deserializer 32. For example, the serializer 17 and the deserializer 32 perform signal conversion of captured image data in accordance with the LVDS standard. The term “LVDS” is an abbreviation for “Low Voltage Differential Signal.” Signals other than captured image data, such as control signals, are also exchanged between the serializer 17 and the deserializer 32.

The camera-internal camera memory 18 is a non-volatile memory, and is comprised, for example, of a flash memory, an EEPROM, or an EPROM. The term “EEPROM” is an abbreviation for “Electrically Erasable Programmable Read-Only Memory,” and “EPROM” is an abbreviation for “Erasable Programmable Read-Only Memory.”

The camera control device 30 has a configuration as a microcomputer and performs various types of control over the camera 12. Specifically, the camera control device 30 includes the deserializer 32, a controller 34, a non-volatile storage 35, and a control-operation storage 36. The controller 34 is communicably connected to each of the deserializer 32, the non-volatile storage unit 35, and the control-operation storage unit 36.

The deserializer 32 is constituted of an electronic circuit including, for example, a plurality of electronic devices. The deserializer 32 converts a serial signal, input from the serializer 17 as captured image data, back into its original parallel signal, and outputs the restored parallel signal to the controller 34.

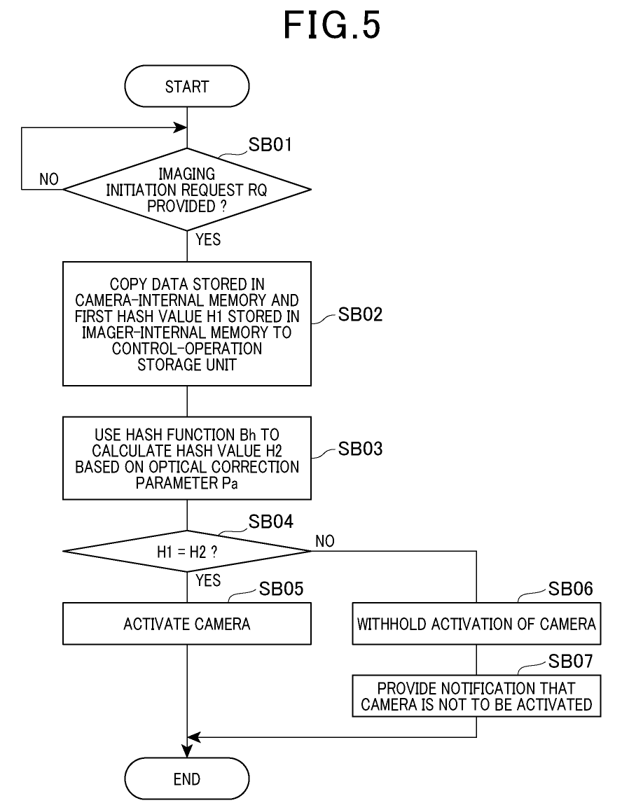

The controller 34 has a configuration as a type of microcomputer and is constituted of, for example, an SoC. The term “SoC” is an abbreviation for “System on a Chip.” The controller 34 performs various control processes such as image processing for captured image data acquired from the camera 12, vehicle control based on the captured image data, and a control process illustrated in FIG. 5 (described later). Examples of vehicle control performed by the controller 34 include automatic brake control and lane-keeping assistance control based on captured image data. The automatic brake control is a vehicle control that automatically applies brakes to the subject vehicle when the subject vehicle approaches a preceding vehicle, in order to mitigate collision damage. The lane-keeping assistance control is a vehicle control that recognizes a lane of a road being traveled and automatically performs steering of the subject vehicle so that the subject vehicle travels along the lane.

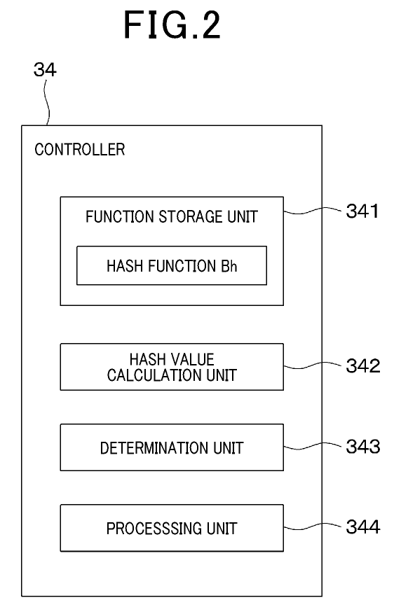

As illustrated in FIG. 2, the controller 34 includes a function storage unit 341, which is, for example, a non-volatile memory within the SoC. A predefined hash function Bh is pre-stored in the function storage unit 341. In the description of the present embodiment, this predefined hash function Bh may be referred to simply as the hash function Bh. Any of various hash functions, such as SHA-256, SHA-512, or SHA3-256, may be employed as the hash function Bh.

As illustrated in FIG. 1, the non-volatile storage unit 35 is a non-volatile memory serving as a non-transitory tangible storage medium, and is constituted of, for example, a flash memory, an EEPROM, or an EPROM. Computer programs for executing various control processes of the controller 34 are pre-stored in the non-volatile storage unit 35. For example,

a computer program for performing the control process illustrated in FIG. 5 (described later) is also pre-stored in the non-volatile storage unit 35. Accordingly, the controller 34 reads and executes the computer program from the non-volatile storage unit 35 as appropriate. Executing this computer program allows a method corresponding to this computer program to be implemented.

The control-operation storage unit 36 is a volatile memory, and is constituted of, for example, a DRAM. The term “DRAM” is an abbreviation for “Dynamic Random Access Memory.”

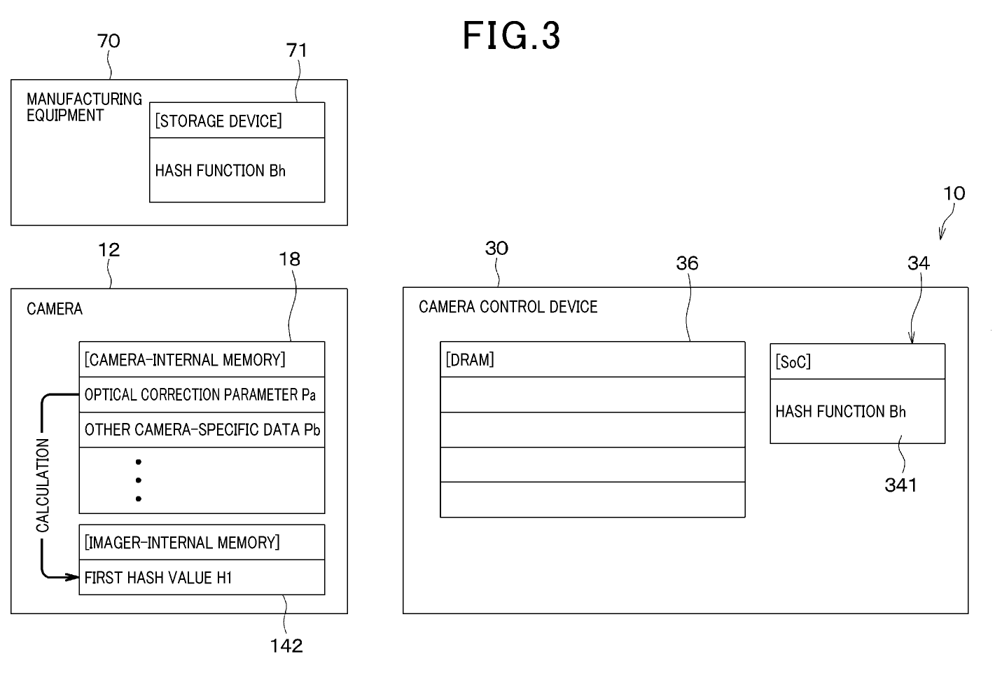

The hardware configuration of the camera system 10 of the present embodiment is as described above. As illustrated in FIG. 3, unique data specific to each individual camera 12 is written into the camera-internal memory 18 and the imager-internal memory 142 during the manufacturing process of the camera 12. The process of manufacturing equipment 70 rewriting this unique data into the camera-internal memory 18 and the imager-internal memory 142 will now be described.

The manufacturing equipment 70 illustrated in FIG. 3 includes a computer (not shown) and a storage device 71 for performing analysis and inspection of the camera 12 being manufactured. The storage device 71 is a non-volatile storage device, which is constituted of, for example, a flash memory or a hard disk. In the storage device 71, a predefined hash function identical to the hash function Bh stored in the function storage unit 341 depicted in FIG. 2 is pre-stored.

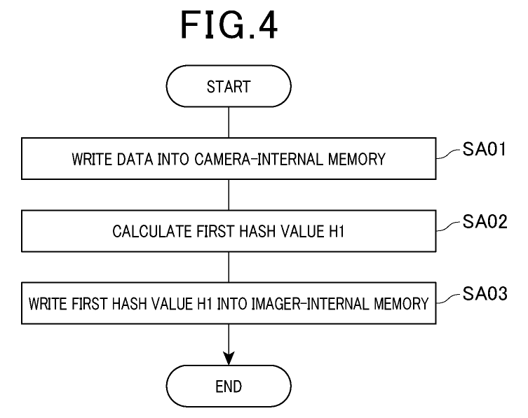

First, at step SA01 in FIG. 4, the manufacturing equipment 70 acquires, among camera-specific data, an optical correction parameter Pa and a plurality of pieces of other camera-specific data Pb as illustrated in FIG. 3. The optical correction parameter Pa corresponds to data to be protected according to the present disclosure.

The optical correction parameter Pa is a correction parameter set to compensate for manufacturing variations among individual cameras 12 and to reduce or eliminate optical distortion in the captured image represented by captured image data output from the imaging unit 141 of the imager 14.

For example, when determining the optical correction parameter Pa, the manufacturing equipment 70 compares a reference image held by the manufacturing equipment 70 with a captured image represented by captured image data output from the imaging unit 141 that has captured the reference image. Then, the manufacturing equipment 70 determines the optical correction parameter Pa so that the difference between the corrected image, acquired by correcting the captured image using the optical correction parameter Pa, and the reference image is minimized. Accordingly, when performing various types of vehicle control such as the aforementioned automatic brake control, the controller 34 corrects captured image data from the camera 12 using the optical correction parameter Pa, and performs the vehicle control using the corrected image data acquired through such correction.

The other camera-specific data Pb refers to parameters or data other than the optical correction parameter Pa. Specific examples of the other camera-specific data Pb include the manufacturing history, manufacturing date, product model number, and serial number of the camera 12.

After acquiring the optical correction parameter Pa and the plurality of pieces of other camera-specific data Pb as described above, the manufacturing equipment 70 writes the optical correction parameter Pa and the plurality of pieces of other camera-specific data Pb into the camera-internal memory 18, as illustrated in FIG. 3. In this manner, the camera-internal memory 18 serving as the data storage in which the optical correction parameter Pa and the plurality of pieces of other camera-specific data Pb are pre-stored is provided. After completion of step SA01 in FIG. 4, the process flow proceeds to step SA02.

At step SA02, the manufacturing equipment 70 reads the optical correction parameter Pa from the camera-internal memory 18 depicted in FIG. 3. Then, the manufacturing equipment 70 calculates a hash value H1 based on the read optical correction parameter Pa by using the hash function Bh that is identical to the hash function stored in the function storage unit 341, specifically, the hash function Bh stored in the storage device 71. That is, in calculation of the hash value H1, the input value for the hash function Bh is the optical correction parameter Pa in the camera-internal memory 18, and the output value from the hash function Bh is the hash value H1. The hash value H1 calculated at step SA02 is referred to as a first hash value H1. After completion of step SA02 in FIG. 4, the process flow proceeds to step SA03.

At step SA03, the manufacturing equipment 70 writes the first hash value H1 calculated at step SA02 into the imager-internal memory 142. In this manner, the imager-internal memory 142, which is a non-rewritable storage in which the first hash value H1, preliminarily calculated using the hash function Bh based on the optical correction parameter Pa, is stored, is provided.

The control process illustrated in FIG. 5, which is performed by the controller 34 of the camera control device 30, will now be described. In order to perform the control process in the flowchart of FIG. 5, the controller 34 of the present embodiment includes, as functional blocks, the function storage unit 341, a hash value calculation unit 342, a determination unit 343, and a processing unit 344, as illustrated in FIG. 2.

By way of clarification, the control process illustrated in FIG. 5 is not performed during manufacturing of the camera system 10, but is performed in the camera system 10 as a finished product. For example, the control process in FIG. 5 is performed while the camera system 10 is in an on-board state.

For example, in the vehicle of the present embodiment, the camera system 10 is activated when a vehicle activation switch operated by an occupant is turned on, and is deactivated when the vehicle activation switch is turned off. That is, both the camera 12 and the camera control device 30 constituting the camera system 10 are activated when the vehicle activation switch is turned on and are deactivated when the vehicle activation switch is turned off. Then, the controller 34 included in the camera control device 30 is activated upon activation of the camera control device 30. When the controller 34 is activated, it initiates the control process illustrated in FIG. 5.

The vehicle activation switch is commonly referred to as an ignition switch. Specifically, when the vehicle activation switch is turned on, the vehicle becomes drivable in response to accelerator operation, and when the vehicle activation switch is turned off, the vehicle becomes undrivable. Although the camera 12 is generally activated in response to the vehicle activation switch being turned on, as described above, there are exceptional cases, as will be described later with reference to FIG. 5, in which the camera 12 is not activated even when the vehicle activation switch is turned on.

Upon initiation of the control process illustrated in FIG. 5, the controller 34 first determines, at step SB01, whether there has been provided an imaging initiation request RQ for initiating an imaging operation by the imaging unit 141 of the imager 14, that is, an imaging initiation request RQ for initiating the imaging operation of the camera 12.

Specifically, in the present embodiment, the controller 34 is configured to receive a switch state signal indicating the switching state (on or off) of the vehicle activation switch. Accordingly, the controller 34 recognizes the switching state and determines that the imaging initiation request RQ has been provided when the vehicle activation switch is switched from off to on. That is, in the present embodiment, the controller 34 is activated when the vehicle activation switch is turned from off to on as described above. Therefore, the controller 34, upon activation, determines at step SB01 that the imaging initiation request RQ has been provided.

If it is determined at step SB01 that the imaging initiation request RQ has been provided, the process flow proceeds to step SB02. On the other hand, if it is determined that the imaging initiation request RQ has not been provided, the process flow returns to step SB01.

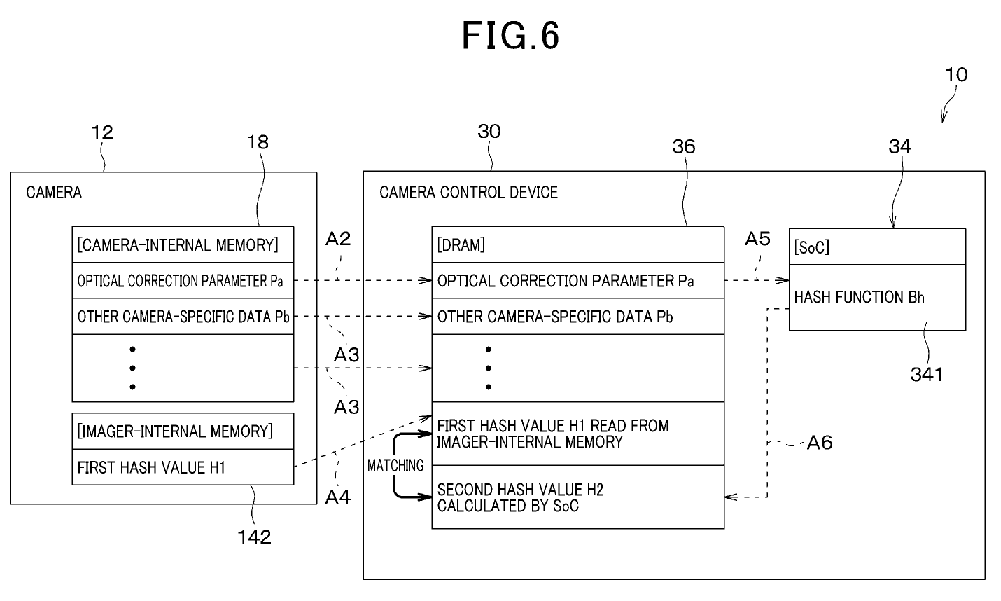

At step SB02 in FIG. 5, the controller 34 reads the optical correction parameter Pa and the plurality of pieces of other camera-specific data Pb stored in the camera-internal memory 18. Then, the controller 34 writes the optical correction parameter Pa and the plurality of pieces of other camera-specific data Pb, read from the camera-internal memory 18, into the control-operation storage unit 36. That is, as indicated by arrow A1 in FIG. 1 and arrows A2 and A3 in FIG. 6, the controller 34 copies the optical correction parameter Pa and the plurality of pieces of other camera-specific data Pb stored in the camera-internal memory 18 to the control-operation storage unit 36.

At step SB02 in FIG. 5, the controller 34 reads the first hash value H1 stored in the imager-internal memory 142. Then, the controller 34 writes the first hash value H1 read from the imager-internal memory 142 into the control-operation storage unit 36. That is, as indicated by arrow A4 in FIG. 6, the controller 34 copies the first hash value H1 stored in the imager-internal memory 142 to the control-operation storage unit 36. After completion of step SB02 in FIG. 5, the process flow proceeds to step SB03.

At step SB03, the hash value calculation unit 342 included in the controller 34 reads the optical correction parameter Pa from the control-operation storage unit 36, as indicated by arrow A5 in FIG. 6. Then, the hash value calculation unit 342 uses the hash function Bh stored in the function storage unit 341 illustrated in FIG. 6 to calculate a hash value H2 based on the optical correction parameter Pa read from the control-operation storage unit 36. That is, in calculation of the hash value H2, the input value for the hash function Bh is the optical correction parameter Pa copied from the camera-internal memory 18 to the control-operation storage unit 36, and the output value from the hash function Bh is the hash value H2.

After calculating the hash value H2, the hash value calculation unit 342 writes the calculated hash value H2 into the control-operation storage unit 36, as indicated by arrow A6. The hash value H2 calculated at step SB03 is referred to as a second hash value H2. After completion of step SB03 in FIG. 5, the process flow proceeds to step SB04.

At step SB04, the determination unit 343 included in the controller 34 first reads the first hash value H1 and the second hash value H2 from the control-operation storage unit 36, as shown in FIG. 6. Then, the determination unit 343 compares the first hash value H1 with the second hash value H2 and determines whether the first hash value H1 and the second hash value H2 match.

If it is determined by the determination unit 343 at step SB04 in FIG. 5 that the first hash value H1 and the second hash value H2 match, the process flow proceeds to step SB05. On the other hand, if it is determined by the determination unit 343 that the first hash value H1 and the second hash value H2 do not match, the process flow proceeds to step SB06.

At step SB05, the processing unit 344 included in the controller 34 causes the imaging unit 141 of the imager 14 to initiate its imaging operation. That is, the processing unit 344 activates the camera 12. The imaging unit 141 continues its imaging operation, for example, until the vehicle activation switch is turned off.

On the other hand, at step SB06, the processing unit 344 keeps the imaging operation of the imaging unit 141 of the imager 14 suspended. That is, the processing unit 344 withholds activation of the camera 12 to keep it in a deactivated state. When the vehicle activation switch is once turned from on to off and then turned on again, the control process of FIG. 5 is initiated again from step SB01. After completion of step SB06 in FIG. 5, the process flow proceeds to step SB07.

At step SB07, the processing unit 344 notifies an occupant that the camera 12 is not to be activated. The notification to the occupant is provided, for example, by displaying on a display within the instrument panel having a speedometer and other indicators arranged, that the camera 12 is not to be activated.

The functions corresponding to the respective steps illustrated in FIGS. 4 and 5 above constitute the functional blocks.

As described above, according to the present embodiment, as illustrated in FIG. 5, upon receipt of the imaging initiation request RQ, the processing from step SB02 onward is performed. At step SB03 in FIG. 5, the same hash function Bh as used for calculation of the first hash value H1 is used to calculate the second hash value H2 based on the optical correction parameter Pa. Then, at step SB04, it is determined whether the first hash value H1 and the second hash value H2 calculated at step SB03 match each other.

In this case, a match between the first hash value H1 and the second hash value H2 means that the optical correction parameter Pa at the time of calculating the second hash value H2 is the same as the value on which the first hash value H1 was based. In contrast, a mismatch between the first hash value H1 and the second hash value H2 means that the optical correction parameter Pa at the time of calculating the second hash value H2 has changed from the value on which the first hash value H1 was based. Therefore, in a case where the optical correction parameter Pa stored in the camera-internal memory 18 is rewritten, it is possible to detect that the optical correction parameter Pa has been rewritten based on the determination result at step SB04. That is, it is possible to detect whether the optical correction parameter Pa has been tampered with, based on the determination result at step SB04.

In a case where a regulation requires a configuration that makes it difficult to tamper with data pre-stored in the camera 12, the camera system 10 can be made compliant with such a regulation.

(1) According to the present embodiment, as illustrated in FIG. 5, when it is determined by the determination unit 343 that the first hash value H1 and the second hash value H2 match, the processing unit 344 causes the imaging unit 141 of the imager 14 to perform the imaging operation at step SB05. Therefore, recognizing that the optical correction parameter Pa has not been tampered with, the controller 34 may use that optical correction parameter Pa for various vehicle control functions.

When it is determined that the first hash value H1 and the second hash value H2 do not match, the imaging operation of the imaging unit 141 of the imager 14 remains suspended, thereby contributing to prevention of tampering with the optical correction parameter Pa.

(2) According to the present embodiment, as illustrated in FIGS. 1 and 2, the imager 14 including the imaging unit 141 and the imager-internal memory 142, together with the camera-internal memory 18, constitutes the camera 12. The controller 34 including the function storage unit 341, the hash value calculation unit 342, the determination unit 343, and the processing unit 344 is provided separately from the camera 12, and constitutes the camera control device 30 that is communicably connected to the camera 12. This allows the camera 12 and the camera control device 30 to be configured separately, while also enabling implementation of a tampering-detection function that detects tampering with the optical correction parameter Pa, without requiring the camera 12 itself to be equipped with that tampering-detection function.

(3) According to the present embodiment, as illustrated in FIG. 1, the imaging unit 141 and the imager-internal memory 142 together constitute an imager 14, which is a single imaging element. Therefore, for example, using the imaging element that includes the OTP memory can simplify the configuration of the camera 12.

### Other Embodiments

(1) In the above-described embodiment, the camera system 10 illustrated in FIG. 1 is an on-board camera system for a vehicle. Alternatively, the camera system 10 may be applied to fields other than vehicles.

(2) In the above-described embodiment, as illustrated in FIG. 1, the serializer 17 of the camera 12 and the deserializer 32 of the camera control device 30 perform signal conversion of captured image data in accordance with the LVDS standard. However, this is merely an example. The signal conversion may alternatively be performed in accordance with a standard other than the LVDS standard. Furthermore, the captured image data may be transmitted as is, without being subjected to signal conversion, between the camera 12 and the camera control device 30.

(3) In the above-described embodiment, at step SB01 in FIG. 5, the controller 34 determines that the imaging initiation request RQ has been provided when the vehicle activation switch is switched from off to on. However, this is merely an example. Alternatively, the controller 34 may determine that the imaging initiation request RQ has been provided based on other information unrelated to the switching state of the vehicle activation switch. For example, when the camera control device 30 receives a command signal from another control device to activate the camera 12, the controller 34 may determine that the imaging initiation request RQ has been provided.

(4) In the above-described embodiment, when it is determined at step SB04 in FIG. 5 that the first hash value H1 and the second hash value H2 do not match, the camera 12 is kept in the deactivated state at step SB06. Then, at step SB07, a notification is provided to the occupant that the camera 12 is not to be activated. However, this is merely an example.

Alternatively, for example, when it is determined that the first hash value H1 and the second hash value H2 do not match, the processing unit 344 may notify the occupant that the optical correction parameter Pa has been tampered with, and at the same time, may activate the camera 12 in the same manner as in the processing of step SB05 in FIG. 5. Still alternatively, when it is determined that the first hash value H1 and the second hash value H2 do not match, the processing unit 344 may notify another control device, which is communicably connected to the camera control device 30, that the optical correction parameter Pa has been tampered with, and may take no action toward the occupant. As described above, when it is determined that the first hash value H1 and the second hash value H2 do not match, the processing unit 344 performs a predefined type of processing. However, various types of processing may be envisioned.

(5) In the above-described embodiment, when performing various types of vehicle control such as the automatic brake control mentioned above, the controller 34 corrects captured image data from the camera 12 using the optical correction parameter Pa illustrated in FIG. 6, and performs the vehicle control using the corrected image data acquired through such correction. However, this is merely an example.

Alternatively, for example, in the various types of vehicle control described above, the controller 34 may first perform a provisional recognition or determination based on uncorrected captured image data, and then proceed with control by using the recognition or determination corrected with the optical correction parameter Pa as a final recognition or determination. In this case, the optical correction parameter Pa is calculated on the premise that it is to be used in such a manner.

(6) In the above-described embodiment, the optical correction parameter Pa stored in the camera-internal memory 18 in FIG. 6 corresponds to data to be protected according to the present disclosure. However, this is merely an example. Alternatively, for example, other data stored in the camera 12, such as other camera-specific data Pb stored in the camera-internal memory 18, may correspond to data to be protected according to the present disclosure. In such a case, the data corresponding to the data to be protected becomes the input value for the predefined hash function Bh used to calculate the first hash value H1 and the second hash value H2. Furthermore, the data corresponding to the data to be protected according to the present disclosure may include one piece of data or a plurality of pieces of data.

(7) In the above-described embodiment, the camera control device 30 illustrated in FIG. 1 does not necessarily have to be an independent device, and may alternatively be incorporated into an on-board electronic control device as a functional component of that electronic control device.

(8) In the above-described embodiment, the processing of each step in the flowcharts of FIGS. 4 and 5 is implemented by a computer program. Alternatively, it may be implemented by hardware.

(9) The present disclosure is not limited to the embodiments described above and may be modified as appropriate. Needless to say, in the above-described embodiments, the components of the embodiments are not necessarily essential unless explicitly stated otherwise or unless they are inherently and clearly essential.

In addition, when a numerical value, such as the number, value, amount, or range, of a component in any of the above-described embodiments is mentioned, such a numerical value is not intended to be limiting unless expressly stated otherwise or unless the context clearly requires such a limitation. Similarly, when the material, shape, positional relationship, or the like of a component in any of the embodiments is mentioned, such descriptions are not intended to be limiting unless explicitly stated otherwise or unless the description inherently requires such a limitation.

The controller 34 and the method thereof described in the present disclosure may be realized by a dedicated computer provided by configuring a processor and memory programmed to perform one or more functions embodied in a computer program. Alternatively, the controller 34 and the method thereof described in the present disclosure may be realized by a dedicated computer provided by configuring a processor with one or more dedicated hardware logic circuits. Alternatively, the controller 34 and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

What is claimed is:

1. A camera system comprising:
a data storage unit storing predefined data to be protected;
a non-rewritable storage unit storing a first hash value that is a hash value pre-calculated using a predefined hash function based on the data to be protected;
an imaging unit configured to perform an imaging operation for converting received light into an electrical signal;
a function storage unit storing the predefined hash function;
a hash value calculation unit configured to, when an imaging initiation request is provided to initiate the imaging operation, calculate a second hash value based on the data to be protected using the predefined hash function stored in the function storage unit; and
a determination unit configured to determine whether the first hash value and the second hash value match.

2. The camera system according to claim 1, further comprising
a processing unit configured to cause the imaging unit to perform the imaging operation when the determination unit determines that the first hash value matches the second hash value.

3. The camera system according to claim 2, wherein
the processing unit is configured to, when the determination unit determines that the first hash value does not match the second hash value, provide a notification that the imaging operation is not to be performed.

4. The camera system according to claim 1, wherein
the data storage unit, the non-rewritable storage unit, and the imaging unit constitute a camera, and
the function storage unit, the hash value calculation unit, and the determination unit constitute a camera control device which is separate from the camera and is communicably connected to the camera.

5. The camera system according to claim 1, wherein
the imaging unit and the non-rewritable storage unit constitute a single imaging element.

6. The camera system according to claim 1, wherein
the first hash value is calculated during a manufacturing process of the camera system.

7. The camera system according to claim 6, wherein
the first hash value stored in non-rewritable storage unit is a hash function calculated during the manufacturing process of the camera system, and
the predefined hash function stored in the function storage unit is the same hash function as that used to calculate the first hash value.

8. The camera system according to claim 1, wherein
the data to be protected is camera-specific data.

9. The camera system according to claim 8, wherein
the camera-specific data includes an optical correction parameter.

10. The camera system according to claim 1, wherein
the camera system is an on-board camera system for a vehicle, and
the imaging initiation request is provided when a vehicle activation switch is turned on.

11. A camera control device for controlling a camera configured to perform an imaging operation for converting received light into an electrical signal, the camera storing predefined data to be protected and storing a first hash value that is a non-rewritable hash value pre-calculated using a predefined hash function based on the data to be protected, the camera control device comprising:
a function storage unit storing the predefined hash function;
a hash value calculation unit configured to, when an imaging initiation request is provided to initiate the imaging operation, calculate a second hash value based on the data to be protected using the predefined hash function stored in the function storage unit; and
a determination unit configured to determine whether the first hash value and the second hash value match.
